(19) United States
(12) Patent Application Publication
(10) Pub. No.: US 2011/0204757 A1
(43) Pub. Date: Aug. 25, 2011

(54) ORGANIZING VALET AND METHOD OF USING SAME

(75) Inventors: Tracey M. Komata, Del Mar, CA (US); Soames S. Haworth, Del Mar, CA (US); Brent T. Hinrichs, Portland, OR (US); Jake W. Eisner, San Francisco, CA (US); Emily H. Sugihara, Del Mar, CA (US); Angus R. Colson, JR., Jamul, CA (US); Terrell A. Oyama, San Diego, CA (US)

(73) Assignee: Blue Angus, Del Mar, CA (US)

(21) Appl. No.: 12/838,310

(22) Filed: Jul. 16, 2010

Related U.S. Application Data
(63) Continuation-in-part of application No. 11/775,620, filed on Jul. 10, 2007, now abandoned.

(51) Int. Cl. A47B 96/00; F16L 3/08; H02B 1/015; B23P 11/00

(52) U.S. Cl. 312/204; 174/500; 29/428

(57) ABSTRACT

The present invention describes a piece of furniture and a method of using and making the same according to certain embodiments of the invention may include an organizing structure having a housing with an open front portion, a movable false interior wall capable of fastening at least a single electrical line and a tray at the uppermost portion wherein said electrical line is accessible.

### RELATED APPLICATIONS

This application is a continuation-in-part of and claims priority to U.S. application Ser. No. 11/775,620, filed Jul. 10, 2007. This application is related to Disclosure Document No. 606049, filed Sep. 14, 2006, and entitled “Doggie Tree or/and Canine Valet.” The disclosures of the above referenced application and disclosure document are incorporated by reference in their entireties herein.

### FIELD OF THE INVENTION

The present invention relates in general to a valet in the nature of a piece of furniture and a method of using and making the same. More particularly, the invention relates to an organizing structure and method of using the structure to house various pet and personal items in a readily accessible and aesthetically pleasing manner the structure also contains a docking station for connecting various electronic devices to an electrical power source.

### BACKGROUND OF THE INVENTION

Furniture pieces are often used to make items easily accessible yet out of sight. Valets are also used for organizational purposes to sort, and store items preventing clutter. In many residences space is often limited making storage valuable therefore organizers should be configured for the most efficient use possible. It is also desirable to have several options for storing and organizing items in a storage unit.

Pet owners living in smaller houses or apartments face many challenges with respect to storing various pet items in an aesthetically pleasing fashion. Pet owners that do not have access to a private yard are required to frequently exercise and walk their pets. For example, dog owners need ready access to leashes, towels, toys, dog waste bags, allowing for easy retrieval when quickly leaving the home. Generally, these various pet items do not complement the ambiance of the home.

Even individuals that do not own pets require several important personal items every time they leave their residence such as, keys, cell phone, glasses, work ID badge, umbrella, wallet or purse. These items require a secure, quick, compact, storage location with easy access. Often times an individual leaves their residence running through a laundry list of items in their head to make sure they have gathered all the items needed, wallet, work badge, phone, keys, mail, and so on. If all these items are neatly organized and accessible in the same location this daunting task will become moot.

Over time furniture modifications to conceal a variety of items have been the subject of many U.S. patents. For example, some modifications include a drape or cloth to conceal various items making the items easily accessible. However, none of the modifications offer a useful solution for storing and organizing daily articles that are necessary when an individual leaves their residence.

It is therefore a principle object of the present invention to provide an improved organizing and storage valet for conveniently housing everyday pet and personal necessities.

### SUMMARY OF THE INVENTION

The disadvantages and shortcomings of previous storage units are eliminated or substantially alleviated by the present invention, which provides such a storage valet permitting compact orderly storage of pet necessities and personal articles. The valet combines the function of an organizer storing personal items as well as a docking and charging station for electronic devices.

Another aspect of the present invention is an organizational tool for everyday personal items.

In still another aspect of the present invention is a docking and charging station for compact electrical devices.

In yet another aspect of the present invention, the valet may be modified with decorative and functional enhancements such as doors, bars, hooks and the like.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a left side vertical cross sectional view of a valet, which is constructed according to an embodiment of the present invention and which is illustrated with certain of its drawers and shelves shown for illustration purposes;

FIG. 2 is an exploded view of the valet of FIG. 1;

FIG. 3 is a left side vertical cross sectional pictorial view of the valet of FIG. 1, as viewed from beneath the valet looking upwards;

FIG. 4 is a left side vertical cross sectional pictorial view of the valet of FIG. 1, as viewed from above the valet looking downwards;

FIG. 5 is a top plan view of the valet of FIG. 1;

FIG. 6 is left side vertical cross sectional view of the valet of FIG. 1;

FIG. 7 is a front plan view of the valet of FIG. 1.

### DETAILED DESCRIPTION OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A piece of furniture and a method of using it according to certain embodiments of the invention may include a valet having a housing with an open front portion, a false interior rear wall defining an electrical line routing space, and an electronic device supporting top tray for communicating with the electrical line routing space.

According to certain embodiments of the invention the electrical line routing space of the valet may further comprise at least one electrical line to provide power to at least one electronic device resting on the top tray of the valet. The at least one electrical line may be an extension cord. The extension cord may split one power source into at least two power sources.

The at least one electrical line may be fastened to the valet, such as to the housing or the false interior rear wall, by way of at least one fastening device. The at least one fastening device may include but is not limited to a cable management clip, a hook, Velcro®, double sided tape, glue, or a combination thereof.

The at least one electronic device resting on the top tray of the valet may include an electric cable that may extend through an opening in the top tray into the electrical line routing space to connect to the at least one electrical line. The opening in the top tray may further include a cable management grommet for the extension of at least one electrical cable.

According to another embodiment of the invention, the valet may further comprise at least one support, wherein the at least one support may be at least one storage shelf, a drawer, or a combination thereof.

The at least one storage shelf may include a lower storage shelf and at least one upper storage shelf. The lower storage shelf may rest upon a rear wood support block and a front wood support block, and may be bent downwards at the front of the shelf to conceal the front wood support block when the valet is viewed from the front.

The downward bend in the storage shelf also allows for easy cleaning when for example shoes are placed on the shelf. The at least one upper storage shelf may be fastened to the housing by way of at least one fastening device, such as a bracket, a screw, a nail, a wood biscuit, a wood dowel, glue, or a combination thereof. The at least one upper storage shelf may be used to store various personal or pet items, and may be bent upwards at the front of the shelf for containment of these various items. For example, if a ball were placed on this shelf it would not roll off.

The drawer may be comprised of a front drawer panel, a rear drawer panel, two side drawer panels, a bottom drawer panel, and a pair of drawer slides. The drawer may further comprise a decorative drawer front. The pair of drawer slides may be fastened to the side drawer panels and the valet housing. The drawer may further include a dispenser, wherein the dispenser may be a removable L shaped dispenser, comprised of a vertical panel, a horizontal panel, and an opening within the horizontal panel, and wherein the dispenser may be used to dispense dog waste bags, tissues, disposable gloves, or a combination thereof.

According to yet another embodiment of the invention, the valet may further comprise a tray base, wherein the tray base may be fastened to the false interior rear wall by way of at least one fastening device, such as a bracket, a screw, a nail, a wood biscuit, a wood dowel, glue, or a combination thereof.

In further embodiments, the top tray may rest upon the tray base, and may be securely or removably fastened to the tray base by way of at least one fastening device, such as a magnet, Velcro®, glue, double sided tape, a screw, a nail, or a combination thereof. Additionally, the top tray may be upholstered with a material, such as fabric, vinyl, leather, suede and the like.

According to other embodiments of the invention, the valet may be comprised of laminated wood, stained wood, plastic, stainless steel, or fiberglass. The valet may be U- or V-shaped throughout its axial height.

According to another embodiment of the invention, the false interior rear wall is moveable. In a preferred embodiment the false interior wall is movable in a vertical direction. An individual may raise the wall to a suitable height to facilitate the exchange of devices to the electrical unit. This advantageous feature avoids moving the piece of furniture to reach a power source each time a device needs to be inserted or removed.

Variations in the illustrated valet itself may still be within the spirit of the invention. One such variation is a valet with doors. Therefore, another embodiment of the invention is, the valet may contain doors, which may be used to cover the open front.

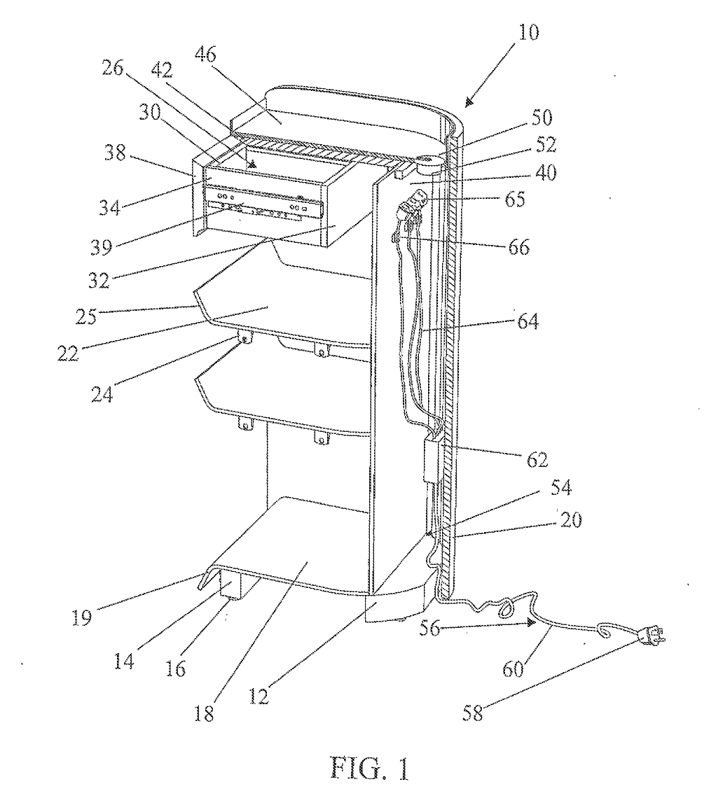

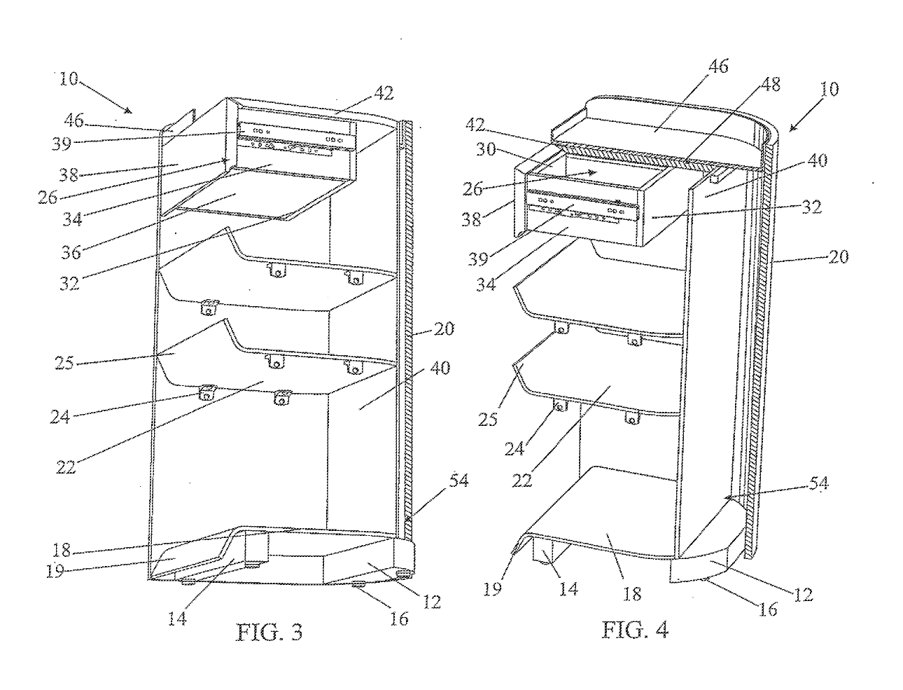

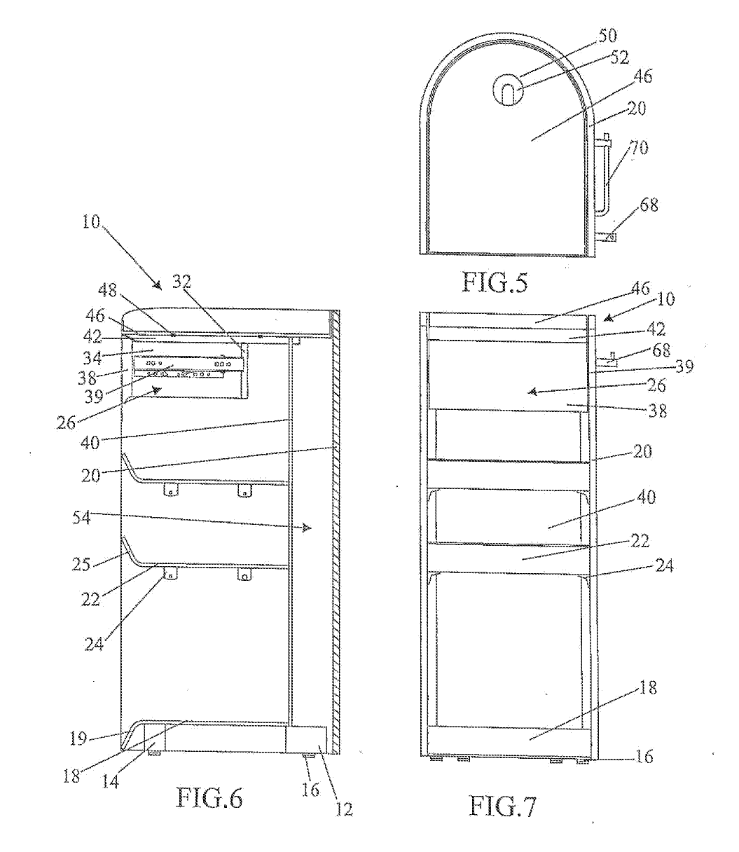

Referring now to the figures, FIGS. 1-4 and 6-7 each show a valet 10 with a rear support block 12 and a front support block 14 at its base. Attached to the bottom of support blocks 12 and 14 are furniture glides 16. A lower shelf 18 may be attached to the tops of support blocks 12 and 14 using wood glue, brackets, screws, nails, wood dowels, wood biscuits, or a combination thereof. The lower shelf 18 may have a downward bent front 19. The downward bent front 19 of lower shelf 18 may conceal the front support block 14 when the valet 10 is viewed from the front.

The support blocks 12 and 14, along with the lower shelf 18, may be surrounded by the open front valet housing 20. The housing 20 may be comprised of laminated wood and it may be U- or V-shaped throughout its axial height.

The valet may further contain at least one upper shelf 22. The at least one upper shelf 22 may be fastened to the valet housing 20 by way of brackets 24, or any other suitable fastening means, such as, a screw, a nail, a wood biscuit, a wood dowel, glue, or any combination thereof. The at least one upper shelf 22 may be used to hold various pet related items, and may have an upward bent front 25 to aid in the containment of these various pet related items.

The valet may further contain at least one drawer 26, wherein the drawer is comprised of a front drawer panel 30, a rear drawer panel 32, two side drawer panels 34, and a bottom drawer panel 36. The at least one drawer 26 may also include a decorative drawer front 38. The at least one drawer 26 may be attached to the valet by drawer slides 39 which are secured to the side drawer panels 34 and the housing 20.

A false interior rear wall 40 may be included in the valet 10, and may be inserted vertically between the back of the shelves 18 and 22 and drawer 26 and the inside of the housing 20, so that it rests upon the rear wood support block 12.

A tray base 42 may be attached to the housing 20, by an attachment means, such as brackets, screws, nails, wood biscuits, wood dowels, glue, or a combination thereof (not shown).

A top tray 46 may rest upon the top of the tray base 42. The top tray 46 may be fixedly or removably attached to the tray base 42 by a removable attachment means, such as magnets 48, or other attachment means, such as Velcro, glue, double sided tape, screws, nails, or a combination thereof (not shown). The top tray may be upholstered with a material, such as fabric, vinyl, leather, or suede (not shown).

FIGS. 1, and 5 depict an opening 50 in the top tray, which may optionally contain a cable management grommet 52. The opening 50 and cable management grommet 52 both allow for the passage of cords from various electronic devices resting on the top tray 46 through the opening 50 and cable management grommet 52 and into the electrical line routing space 54, which is located between the back of the false interior rear wall 40 and the inside surface of the housing 20.

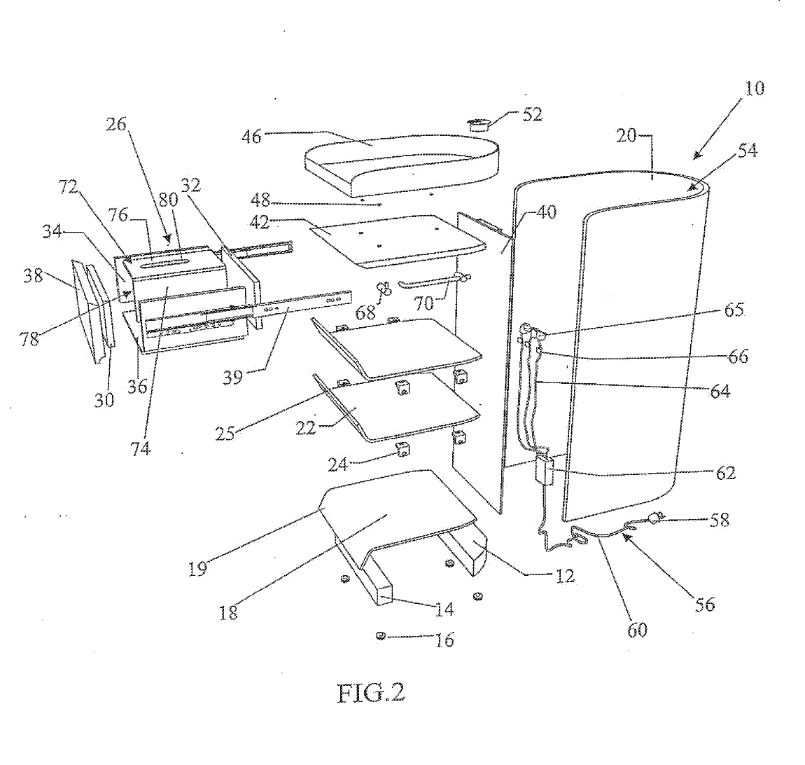

Once within the electrical line routing space 54, the electronic device cords may be connected to an extension cord 56, shown in FIGS. 1 and 2. Extension cord 56 may contain an outlet plug 58 for receiving electrical power, a wire cable 60 for transferring electrical power, a splitter box 62 for splitting the power from one cable to two or more sets of outlet cables 64 having outlets 65 for providing power. The outlet cables 64 may be attached to the valet 10, such as, for example, to the false interior rear wall 40 or the housing 20, by cable management clips 66.

As shown in FIGS. 2, 5, and 7, the valet 10 may include a leash hook 68 and a towel bar 70. In a preferred embodiment the hooks are securely attached to the valet but movable so that they may lie flush against a sidewall of the valet when not in use.

FIG. 2 shows an exploded view of the valet 10. This exploded view also depicts the optionally included dispenser 72, which may be comprised of a vertical panel 74 and a horizontal panel 76, attached so as to create an L-shape. This arrangement creates a storage space 78 within the dispenser for retaining items such as dog waste bags, tissues, or disposable gloves. These items stored within the dispenser may be retrieved via an opening in the horizontal panel 80.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

### Materials and Methods

Methods and materials are described herein. However, methods and materials similar or equivalent to those described herein can be also used to obtain variations of the present invention. The materials, methods, and examples are illustrative only and not intended to be limiting

### Incorporation by Reference

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Other Embodiments

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A valet for storing pet and personal items, comprising:
rear, side, top and bottom walls defining a cavity;
a bottommost portion and an uppermost portion;
a false wall inside said valet wherein said false wall is vertically movable creating an electrical line routing space;
said bottommost portion enclosed with a horizontal bottom shelf said bottom shelf having an interior bottom shelf end and an exterior bottom shelf end, said interior bottom shelf end is attached to said false wall and said exterior bottom end is curved downward;
at least a single horizontal shelf having an horizontal shelf interior end and a horizontal shelf exterior end, said horizontal shelf interior end is attached to said false wall and said horizontal shelf exterior end is curved upward;
said false wall inside said valet having a means for fastening at least a single electrical line wherein said electrical line has a first end and a second end; and
said upper portion of said valet forms a tray wherein said electrical cord first end is exposed.

2. The valet in claim 1, wherein below said tray is a compartment said compartment selected from the group consisting of a pull out drawer attached by sliding hinges or a flip down drawer attached by a flip down hinges.

3. The valet in claim 2, wherein said pull out drawer or said flip down drawer contains a dispenser with a small opening.

4. The valet in claim 1 wherein, said valet further comprises a means for hanging articles selected from the group consisting of a bar, hook, peg, dowel, chain or any combination thereof.

5. The valet in claim 1, wherein said electrical line routing space further comprises at least one electrical line to provide power to at least one electronic device resting on said tray of said valet.

6. The valet in claim 5, wherein said at least one electrical line is an extension cord splitting one power source into at least two power sources.

7. The valet in claim 6, wherein the opening in the top tray includes a cable management grommet.

8. The valet of claim 1, wherein said tray rests upon the uppermost portion and wherein said tray is fastened to the tray base by way of at least one fastening device.

9. A method of using said valet in claim 1 comprising:
placing and/or removing an item selected from the group consisting of leash, ball, waste bag, towel, keys, cell phone, glasses, work ID badge, umbrella, wallet, purse, flash drive on either said shelf or said tray.

10. A method of making a valet for storing pet and personal items, comprising:
providing a rear, side, top and bottom walls defining a cavity having a bottommost portion and an uppermost portion;
mounting a false wall inside said valet wherein said false wall is vertically movable creating an electrical line routing space;
enclosing said bottommost portion with a horizontal bottom shelf said bottom shelf having an interior bottom shelf end and an exterior bottom shelf end;
attaching said interior bottom shelf end to said false wall and curving downward said exterior bottom end;
mounting at least a single horizontal shelf having an horizontal shelf interior end and a horizontal shelf exterior end, attaching said horizontal shelf interior end to said false wall and curving said horizontal shelf exterior end upward;
fastening at least a single electrical line to said false wall inside said valet wherein said electrical line has a first end and a second end; and
forming said upper portion of said valet a tray wherein said electrical cord first end is exposed.
